(19) United States
(12) Patent Application Publication
(10) Pub. No.: US 2008/0067167 A1
(43) Pub. Date: Mar. 20, 2008

(54) Heating cooker with cooling device and method of controlling the same

(75) Inventors: Han Jun Sung, Yongin-si (KR); Dae Sung Han, Hwaseong-si (KR); Yong Hyun Kwon, Suwon-si (KR); Seok Weon Hong, Yongin-si (KR); Tae Uk Lee, Suwon-si (KR); Pung Yeun Cho, Suwon-si (KR); Han Seong Kang, Hwasung-si (KR); Sung Soo Park, Hwaseong-si (KR); Sung Kwang Kim, Ansan-si (KR); Tae Hun Kim, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/826,657

(22) Filed: Jul. 17, 2007

(30) Foreign Application Priority Data
Sep. 18, 2006 (KR) 2006-90296

(51) Int. Cl. H05B 3/68

(52) U.S. Cl. 219/448.17; 219/448.11

(57) ABSTRACT

Provided is a heating cooker which includes a body constituting an appearance thereof, an upper panel on which a cooking container is laid, a heater positioned under the upper panel to heat the cooking container laid on the upper panel, a fan housing liftably positioned at one side of the body to be raised above the upper panel and having an air intake port and an air discharge port, a blast fan and a fan motor positioned in the fan housing to forcibly blow air toward a surface of the upper panel, a fan housing lifter to raise and lower the fan housing, a temperature sensor to detect the temperature of the upper panel, and a controller to control the heater, the fan motor, and the fan housing lifter. The upper panel heated by the heater can be forcibly cooled by air from the fan housing.

### CROSS-REFERENCE TO RELATED APPLICATIONS

This application claims the benefit under 35 U.S.C. § 119 of Korean Patent Application No. 2006-0090296, filed on Sep. 18, 2006 in the Korean Intellectual Property Office, the disclosure of which is incorporated herein by reference.

### BACKGROUND

1. Field

The present invention relates to a heating cooker and a method of controlling the same, and, more particularly, to a heating cooker which can forcibly cool a surface of an upper panel on which a cooking container is laid, and a method of controlling the same.

2. Description of the Related Art

Generally, heating cookers can be classified into gas cooking devices that heat food or cooking containers with gas combustion heat, and electric cooking devices that heat the food or the cooking containers with electric energy. For the electric cooking devices, there are an electro-thermal cooker which directly heats the food or the cooking containers by use of heat generated from an electrothermal body, an induction heating cooker which heats the cooking container by use of eddy currents, a microwave oven which heats the food via penetration of microwaves generated from super high frequency oscillator into the food, etc.

Recently, multi-functional cookers have been widely supplied, which can perform various cooking operations, such as roasting, frying, steaming, boiling, thawing, etc. Such multi-functional cookers include a gas oven, an electrical oven, and a combination oven which employs both gas and electricity.

The multi-functional cooker has several cooking units to allow various cooking operations. For example, the electrical microwave oven includes a cooking chamber to receive cooking containers or food and to heat the cooking containers and food evenly throughout, and an upper panel having a heater disposed thereon to heat the cooking container.

A cook-top type heating cooker is disclosed as an example of the electrical microwave oven in U.S. Patent Publication No. 2003-0029858, published Feb. 13, 2003, and includes an upper panel and a temperature sensor positioned under the upper panel.

In the heating cooker of the related art, a heater is positioned near the temperature sensor under an upper panel made from a ceramic material. The heater includes a heating conductor which is supplied with power to generate heat, and the temperature sensor detects the heating temperature in preparation for control of the power supplied to the heating conductor. When the heating conductor generates heat through application of power thereto, the cooking container laid on the surface of the upper panel is heated to perform the cooking operation.

Such a conventional heating cooker has a problem in that, since the upper panel remains heated for a long period of time after the cooking operation and the application of the power to the heating conductor are finished, there can be an accident caused by carelessness of a user.

In order to prevent such a problem, the conventional heating cooker is provided at an exterior with an alarm light such that, if the upper panel has a predetermined temperature or more even after the heater is turned off, the alarm light is lit, thus warning the user.

However, since the upper panel of the conventional heating cooker remains still heated for a significantly long period of time after the cooking operation, there is a high likelihood of an accident, such as serious burns caused by the carelessness of the user, even with such an alarm light.

### SUMMARY

Therefore, it is an aspect to provide a heating cooker, which can forcibly cool a heated upper panel after a cooking operation to reduce or remove likelihood of an accident, such as burns caused by carelessness of a user, and a method of controlling the same.

Additional aspects and/or advantages of the embodiments will be set forth in part in the description which follows and, in part, will be obvious from the description, or may be learned by practice of the embodiments.

In accordance with one aspect, a heating cooker is provided, including: a body constituting an appearance of the heating cooker; an upper panel on which a cooking container may be laid; a heater positioned under the upper panel to heat the cooking container laid on the upper panel; and a surface cooling device to cool the upper panel.

The surface cooling device may include a blast fan to forcibly blow air toward a surface of the upper panel, and a fan motor to operate the blast fan.

The surface cooling device may further include a fan housing to receive the blast fan and the fan motor, the fan housing being liftably positioned at one side of the body to be raised above the upper panel and being formed with an air discharge port through which air blown by the blast fan is discharged toward the surface of the upper panel.

The fan housing may be provided with a blow guide to guide the air blown by the blast fan to descend toward the surface of the upper panel.

The heating cooker may further include a fan housing lifter to raise and lower the fan housing.

The fan housing lifter may include a rack positioned at one side of the fan housing, a pinion engaged with the rack, and a motor to rotate the pinion.

The heating cooker may further include an emission duct positioned at the other side of the body to guide the air discharged from the fan housing and flowing on the upper panel, the emission duct including an air inlet through which the air flowing on the upper panel enters the emission duct and an air outlet through which the air induced through the air inlet is emitted.

The emission duct may be liftably attached to the body to allow the air inlet to be raised above the upper panel.

The heating cooker may further include an emission duct lifter to raise and lower the emission duct.

The emission duct lifter may include a rack positioned at one side of the emission duct, a pinion engaged with the rack, and a motor to rotate the pinion.

The foregoing and/or other aspects are achieved by providing a heating cooker, including: a body constituting an appearance of the heating cooker; an upper panel on which a cooking container may be laid; a heater positioned under the upper panel to heat the cooking container laid on the upper panel; a surface cooling device to cool the upper panel; and a controller to control the heater and the surface cooling device.

The heating cooker may further include a temperature sensor to detect a temperature of the upper panel, the controller controlling the surface cooling device in response to signals from the temperature sensor.

The foregoing and/or other aspects of the present invention are achieved by providing a method of controlling a heating cooker, including raising a fan housing having a blast fan and a fan motor received therein above an upper panel when a heater positioned under the upper panel is turned off after completion of a cooking operation; driving the fan motor to blow air toward the upper panel; and stopping the fan motor when the upper panel is cooled, followed by retracting the fan housing to its original position.

The method may further include detecting a temperature of the upper panel, and the stopping of the fan motor followed by the retracting of the fan housing may be performed when the detected temperature is lower than a predetermined temperature.

The stopping of the fan motor followed by the retracting of the fan housing may be performed with an elapse of a predetermined time after the driving of the fan motor.

The foregoing and/or other aspects are achieved by providing a heating cooker including an upper panel; at least one heater positioned beneath the upper panel; at least one temperature sensor detecting a temperature of a portion of the upper panel; and a liftably retractable surface cooling device cooling the upper panel.

### BRIEF DESCRIPTION OF THE DRAWINGS

These and/or other aspects and advantages will become apparent and more readily appreciated from the following description of the embodiments, taken in conjunction with the accompanying drawings, of which:

FIG. 1 is a perspective view of a heating cooker according to a first embodiment of the present invention;

FIG. 2 is a block diagram showing components of the heating cooker according to the embodiments of the present invention;

FIG. 3 is a front view showing a major component of the heating cooker according to the first embodiment of the present invention;

FIG. 4 is a side sectional view showing a major component of the heating cooker according to the embodiment of the present invention;

FIG. 5 is a front view illustrating operation of the heating cooker according to the first embodiment of the present invention;

FIG. 6 is a flow chart illustrating a method of controlling the heating cooker according to the first embodiment of the present invention; and

FIG. 7 is a schematic front view of a heating cooker according to a second embodiment of the present invention.

### DETAILED DESCRIPTION OF THE EMBODIMENTS

Reference will now be made in detail to the embodiments, examples of which are illustrated in the accompanying drawings, wherein like reference numerals refer to the like elements throughout the drawings. The embodiments are described below to explain the invention by referring to the figures.

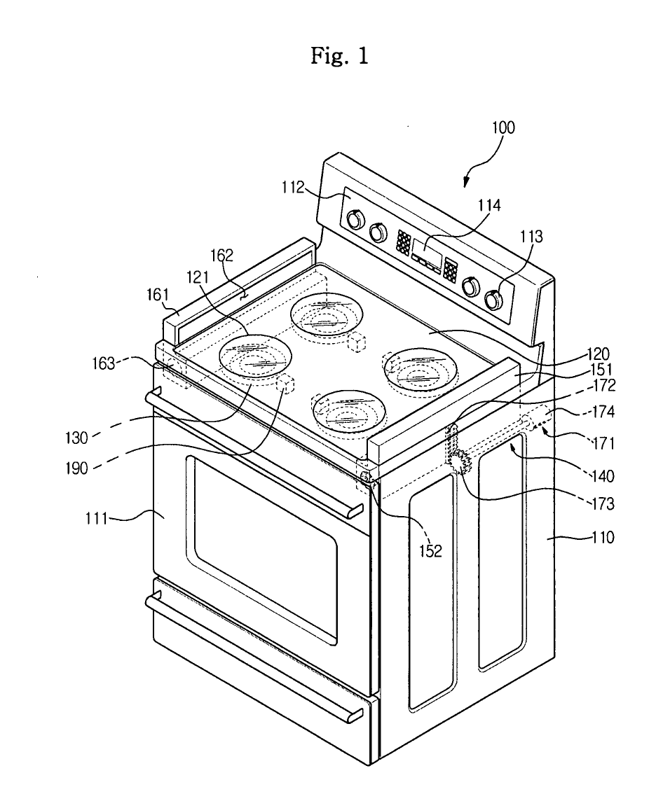

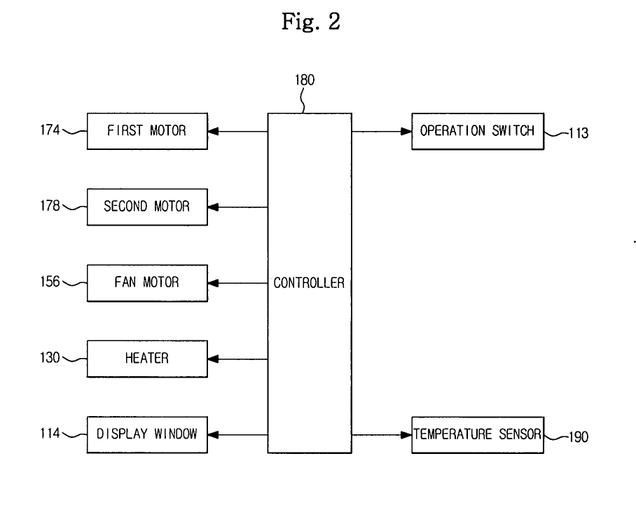

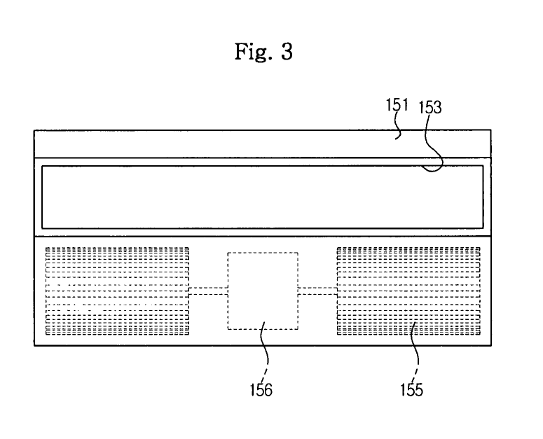

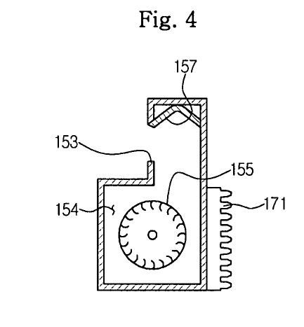

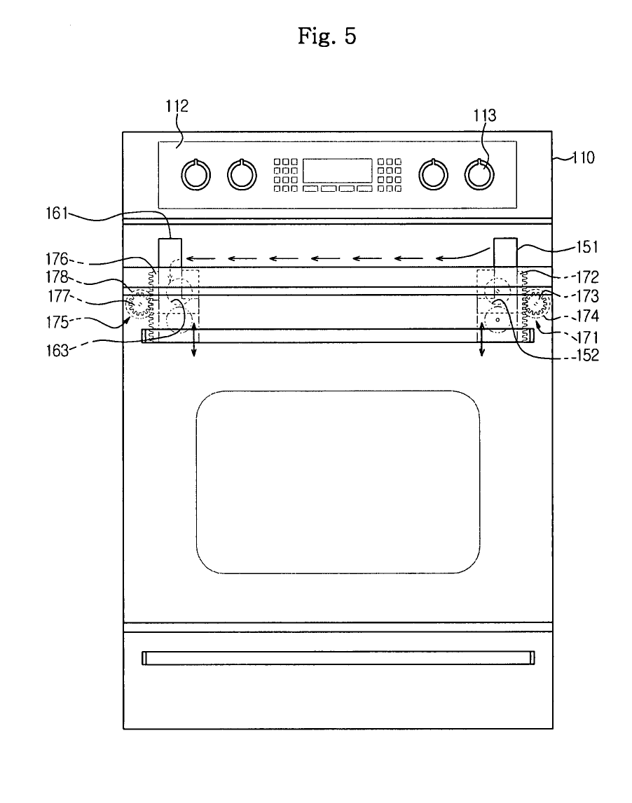

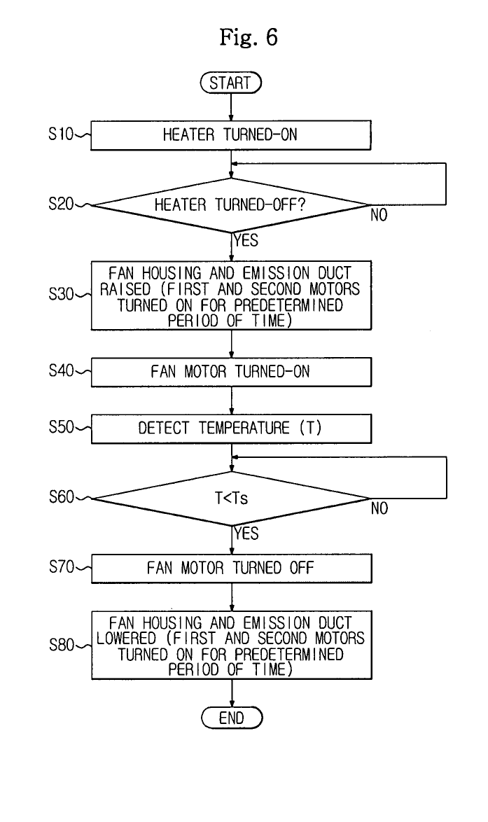

FIG. 1 is a perspective view of a heating cooker according to a first embodiment of the invention, FIG. 2 is a block diagram showing components of the heating cooker, FIGS. 3 and 4 are a front view and a side sectional view showing a major component of the heating cooker, FIG. 5 is a front view illustrating operation of the heating cooker, and FIG. 6 is a flow chart illustrating a method of controlling the heating cooker according to a first embodiment of the invention.

Referring to FIGS. 1 and 2, the heating cooker 100 according to a first embodiment includes a body 110 constituting an appearance thereof, an upper panel 120 on the body 110, a plurality of heaters 130 under the upper panel 120, a surface cooling device 140 liftably positioned at both sides of the body 110, and a controller 180 to control the heating cooker 100.

The body 110 is provided at a front side with a door 111, and at one side of an upper portion with a control panel 112. The body 110 has a cooking chamber (not shown) which is defined to receive a cooking container or food therein and is opened and closed by the door 111. The control panel 112 may include various operation switches 113 for a user's manipulation, and a display window 114 to show the state of the heating cooker 100. An installation space is defined between the cooking chamber and either side of the body 110.

The upper panel 120 may be made of a ceramic material. Provided on the surface of the upper panel 120 is a plurality of surface heating parts 121 on which the cooking container can be laid. Each of the heaters 130 is located under a corresponding surface heating part 121 to heat the surface heating part 121. Thus, with the cooking container seated on the surface heating part 121, the corresponding heater 130 may be operated to heat the cooking container and perform the cooking operation.

The plural heaters 130 are positioned under the respective surface heating parts 121 and heat the corresponding surface heating parts 121. The heaters 130 may be radiant heaters, halogen heaters, or any other type of heating device.

The surface cooling device 140 serves to forcibly cool the upper panel 120 heated by any of the heaters 130 after completing the cooking operation. The surface cooling device 140 includes a fan housing 151 and an emission duct 161 liftably positioned at either side of the body 110 to protrude above the upper panel 120.

The fan housing 151 has an air intake port 152 through which air is sucked into the fan housing 151, and an air discharge port 153 (shown in FIG. 3) through which the air is discharged from the fan housing 151. The air intake port 152 is formed at either side of the fan housing 151 as shown in FIG. 1, and the air discharge port 153 is formed at an upper front side of the fan housing 151 as shown in FIGS. 3 and 4. A blowing chamber 154 is defined in the fan housing 151, and is installed therein with a blast fan 155 to forcibly blow air and a fan motor 156 to drive the blast fan 155. The fan housing 151 is provided at an inside upper portion with a blow guide 157 to guide air blown by the blast fan 155 toward the air discharge port 153. The blow guide 157 is bent to have gentle slopes, and disposed longitudinally along the air discharge port 153. The blow guide 157 serves to change a flow direction of the air blown from the blowing chamber 154 and to guide the air discharged through the air discharge port 153 to be directed downward.

When the fan housing 151 is raised above the upper panel 120, the air discharge port 153 is directed to the surface of the upper panel 120. Then, as the blast fan 155 is actuated, air is sucked into the blowing chamber 154 through the air intake port 152, flows toward the blow guide 157 from the blowing chamber 154, and is then discharged toward the surface of the upper panel 120 through the air discharge port 153 along the blow guide 157.

The fan housing lifter 171 raises and lowers the fan housing 151 above and below the upper panel 120. Referring to FIG. 1, the fan housing lifter 171 includes a rack 172 positioned at a rear of the fan housing 151, a pinion 173 engaging with the rack 172, and a first motor 174 to drive the pinion 173. When the pinion 173 is rotated in the clockwise or counterclockwise direction through operation of the first motor 174, the rack 172 is forced upward or downward to raise or lower the fan housing 151. The first motor 174 is controlled by the controller 180.

As shown in FIG. 1, the emission duct 161 is liftably positioned opposite the fan housing 151 with the upper panel 120 disposed therebetween. The emission duct 161 has an air inlet 162 through which air discharged from the fan housing 151 and then flowing past the surface of the upper panel 120 is induced into the emission duct 161, and an air outlet 163 through which the air induced into the emission duct 161 is emitted to the outside. The air inlet 162 has an elongated shape formed at an upper portion of the emission duct 161 to face the air discharge port 153 of the fan housing 151, and the air outlet 163 is positioned at either side of the emission duct 161 to allow the air to be emitted in front and rear directions of the body 110.

With such a configuration as described above, the emission duct 161 is raised above the upper panel 120 along with the fan housing 151, and then guides the air, which is discharged from the fan housing 151 and then flows past the surface of the upper panel 120, into the body 110. In this embodiment, the air outlet 163 may be formed at other locations, such as lower portions of the emission duct 161, rather than either side of the emission duct 161, to emit the air towards other portions within the body 110.

Turning now to FIG. 5, as in the fan housing lifter 171, an emission duct lifter 175 includes a rack 176 positioned at the rear of the emission duct 161, a pinion 177 engaging with the rack 176, and a second motor 178 to drive the pinion 177. When the pinion 177 is rotated in the clockwise or counterclockwise direction through operation of the second motor 178, the rack 176 is forced upward or downward to raise or lower the emission duct 161. The second motor 178 is controlled by the controller 180.

Referring to FIG. 2, the controller 180 controls the first and second motors 174 and 178, the fan motor 156, the heater 130, and the display window 114 in response to signals from the operation switches 113 and temperature sensors 190. The temperature sensors 190 are positioned proximate the respective heaters 130 under the upper panel 120 to detect the temperature of the upper panel 120 heated by the heaters 130.

For the heating cooker 100 of this embodiment, the surface cooling device 140 can be manually or automatically actuated. In other words, the surface cooling device 140 may be actuated by manipulating a separated actuation switch able to be manipulated by a user, or may be automatically actuated by the controller 180 after the cooking operation. Cessation of the cooling by the surface cooling device 140 is automatically performed in response to a detection signal via the temperature sensor 190 when the temperature of the upper panel 120 is lowered to or less than a predetermined degree.

Meanwhile, the fan housing lifter 171 and the emission duct lifter 175 that raise and lower the fan housing 151 and the emission duct 161 commonly employ various linear movement devices, such as cams, links, ball screws, worm gears, etc., as well as using the rack and pinion.

Operation and control method of the heating cooker 100 according to the first embodiment of the invention will hereinafter be described with reference to FIGS. 5 and 6.

With a cooking container laid on the surface heating part 121 of the upper panel 120, a corresponding heater 130 (see FIG. 1) is turned on (S10) to heat the surface heating part 121, performing a cooking operation. With an elapse of time after the heater 130 is turned on, the controller 180 (see FIG. 2) determines whether or not the heater is turned off (S20). If it is determined that the heater is not turned off, the routine returns to S20 until the heater is determined to be turned off. If it is determined that the heater 130 is turned off by completion of the cooking operation, the controller 180 actuates the first and second motors 174 and 178 for a predetermined period of time to raise the fan housing 151 and the emission duct 161 above the upper panel 120 (S30). Here, the air discharge port 153 of the fan housing 151 and the air inlet 162 of the emission duct 161 are positioned above the surface of the upper panel 120 and face each other with the upper panel 120 disposed therebetween. Then, the controller 180 drives the fan motor 156 (see FIG. 3) to rotate the blast fan 155 (S40). As the blast fan 155 is rotated, air flows along the blow guide 157 from the blowing chamber 154, and is discharged downwardly through the air discharge port 153.

After being discharged through the air discharge port 153, the air flows past the surface of the upper panel 120 toward the emission duct 161 while cooling the upper panel 120 heated by the heater 130. Then, the air is induced into the emission duct 161 through the air inlet 162 of the emission duct 161, and discharged to the outside through the air outlet 163 thereof.

While the air discharged from the fan housing 151 cools the upper panel 120, the controller 180 detects a temperature T of the upper panel 120 by use of an associated temperature sensor 190 (S50), and determines whether the temperature T is lower than a predetermined temperature Ts (S60). Here, it is desirable that the predetermined temperature be sufficiently low to prevent a user from being burned. If the detected temperature T is not lower than the predetermined temperature Ts, the routine returns to S60 until the temperature T is detected to be lower than the predetermined temperature Ts.

When the detected temperature T is lower than the predetermined temperature Ts due to sufficient cooling of the upper panel 120, the controller 180 stops the fan motor 156 (S70), and actuates the first and second motors 174 and 178 for a predetermined period of time to descend the fan housing 151 and the emission duct 161 to their original positions (S80).

According to the present embodiment, position detection sensors may be respectively positioned near the fan housing 151 and the emission duct 161 to detect raised positions of the fan housing 151 and the emission duct 161. In this case, the controller 180 controls the first and second motors 174 and 178 in response to signals from the position detection sensors.

The controller 180 may return the fan housing 151 and the emission duct 161 to their original positions after raising the fan housing 151 and the emission duct 161 and operating the fan motor 156 for a predetermined period of time. In this case, the operating time of the fan motor 156 may be determined through experiment so as to allow the upper panel 120 to be sufficiently cooled by the blown air.

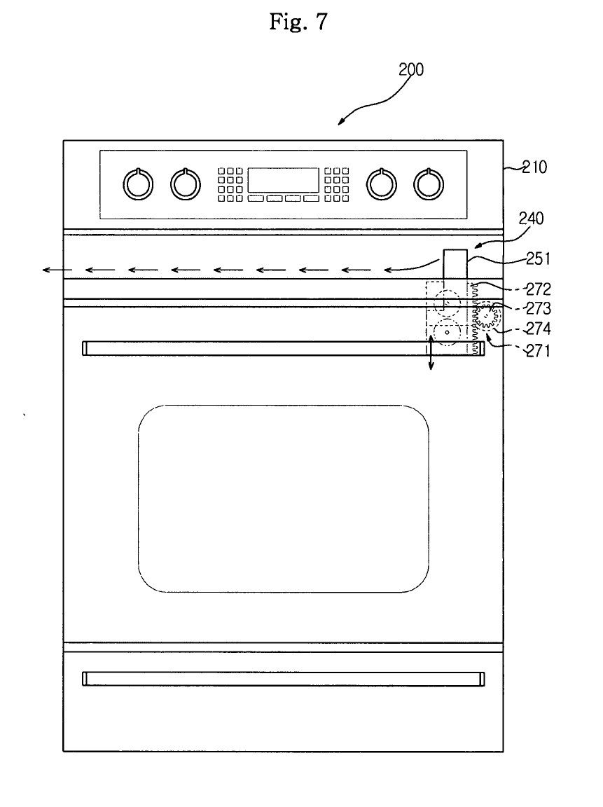

Referring to FIG. 7, a heating cooker 200 according to a second embodiment of the invention is schematically shown in a front view.

The heating cooker 200 according to this embodiment has a similar configuration to that of the above embodiment except that a surface cooling device 240 is constituted without using the emission duct.

Specifically the heating cooker 200 according to this embodiment includes a body 210, an upper panel 120 (see FIG. 1), a plurality of heaters 130 (see FIG. 1), a surface cooling device 240, a plurality of temperature sensors 190 (see FIG. 1), and a controller 180 (see FIG. 2). The surface cooling device 240 includes a fan housing 251 liftably positioned at one side of the body 210, a blast fan 155 (see FIG. 3) and a fan motor 156 (see FIG. 3) positioned in the fan housing 251, and a fan housing lifter 271 to raise or lower the fan housing 251. The fan housing 271 includes a rack 272, a pinion 273, and a motor 274.

When the cooking operation is finished, the fan housing 251 is raised above the upper panel 120, and blows air over the surface of the upper panel 120. Then, the air flows past the surface of the upper panel 120 toward an opposite side of the fan housing 251 while cooling the upper panel 120.

As apparent from the above description, for the heating cooker according to the embodiments, since air is forced to flow past the surface of the upper panel 120 heated by the heater 130 to cool the upper panel 120 after completion of cooking, it is possible to reduce or remove the likelihood of an accident, such as burns, caused by carelessness of a user.

In addition, for the heating cooker according to the embodiments, the fan housing 151 is raised above the upper panel 120 before the upper panel is cooled to a suitable temperature, making the user more cautious about the heated upper panel 120.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A heating cooker, comprising:
a body constituting an appearance of the heating cooker;
an upper panel on which a cooking container may be laid;
at least one heater positioned under the upper panel to heat the cooking container laid on the upper panel; and
a surface cooling device to cool the upper panel.

2. The heating cooker according to claim 1, wherein the surface cooling device comprises a blast fan to forcibly blow air toward a surface of the upper panel, and a fan motor to operate the blast fan.

3. The heating cooker according to claim 2, wherein the surface cooling device comprises a fan housing to receive the blast fan and the fan motor, the fan housing being liftably positioned at one side of the body to be raised above the upper panel and being formed with an air discharge port through which air blown by the blast fan is discharged toward the surface of the upper panel.

4. The heating cooker according to claim 3, wherein the fan housing is provided with a blow guide to guide the air blown by the blast fan to descend toward the surface of the upper panel.

5. The heating cooker according to claim 3, further comprising:
a fan housing lifter to raise and lower the fan housing.

6. The heating cooker according to claim 5, wherein the fan housing lifter comprises a rack positioned at one side of the fan housing, a pinion engaged with the rack, and a first motor to rotate the pinion.

7. The heating cooker according to claim 3, further comprising: an emission duct positioned at the other side of the body to guide the air discharged from the fan housing and flowing on the upper panel, the emission duct comprising an air inlet through which the air flowing on the upper panel enters the emission duct, and an air outlet through which the air induced through the air inlet is emitted.

8. The heating cooker according to claim 7, wherein the emission duct is liftably attached to the body to allow the air inlet to be raised above the upper panel.

9. The heating cooker according to claim 8, further comprising:
an emission duct lifter to raise and lower the emission duct.

10. The heating cooker according to claim 9, wherein the emission duct lifter comprises a rack positioned at one side of the emission duct, a pinion engaged with the rack, and a second motor to rotate the pinion.

11. The heating cooker according to claim 1, further comprising: a controller to control the heater and the surface cooling device.

12. The heating cooker according to claim 11, further comprising: a temperature sensor to detect a temperature of the upper panel, wherein the controller controls the surface cooling device in response to signals from the temperature sensor.

13. A method of controlling a heating cooker, comprising:
raising a fan housing, from an original position of the fan housing, having a blast fan and a fan motor received therein above an upper panel when a heater positioned under the upper panel is turned off after completion of a cooking operation;
driving the fan motor to blow air toward the upper panel; and
stopping the fan motor when the upper panel is cooled, followed by retracting the fan housing to the original position of the fan housing.

14. The method according to claim 13, further comprising:
detecting a temperature of the upper panel, wherein the stopping of the fan motor followed by the retracting of the fan housing is performed when the detected temperature is lower than a predetermined temperature.

15. The method according to claim 13, wherein the stopping of the fan motor followed by the retracting of the fan housing is performed with an elapse of a predetermined time after the driving of the fan motor.

16. A heating cooker, comprising:
an upper panel;
at least one heater positioned beneath the upper panel;
at least one temperature sensor detecting a temperature of a portion of the upper panel; and
a liftably retractable surface cooling device cooling the upper panel.

17. The heating cooker according to claim 16, wherein the surface cooling device is lifted to cool the upper panel after the heater has been turned on and then turned off.

18. The heating cooker according to claim 17, wherein the surface cooling device includes a fan, the fan being turned on to cool the upper panel after the surface cooling device is lifted.

19. The heating cooker according to claim 18, wherein the fan is turned off after the temperature detected by the temperature sensor falls below a predetermined temperature.

20. The heating cooker according to claim 19, wherein the surface cooling device is retracted to an original position after the fan is turned off.
